(19) United States
(12) Patent Application Publication
(10) Pub. No.: US 2026/0242188 A1
(43) Pub. Date: Aug. 20, 2026

(54) Electric winch with autonomous clutch

(71) Applicant: Zhejiang Normal University, Jinhua (CN)

(72) Inventors: Ying DONG, Jinhua (CN); Zhanhui CHANG, Jinhua (CN)

(21) Appl. No.: 19/641,636

(22) Filed: Apr. 8, 2026

(30) Foreign Application Priority Data
May 27, 2025 (CN) 202510687515.1

(51) Int. Cl. B66D 1/12; B66D 1/14

(52) U.S. Cl. CPC B66D 1/12; B66D 1/14

(57) ABSTRACT

The present disclosure provides an electric winch with autonomous clutch, which can realize the autonomous engagement and disengagement of the drum. By installing a contact clutch in the transmission assembly of the electric winch, the drum and the actuation device can be engaged and disengaged autonomously at the contact clutch position. Thus, the user can autonomously control the rope release speed when needed, and the drum can be engaged instantly by the operation of the motor when engagement is required.

### CROSS-REFERENCE TO RELATED APPLICATION

This application claims priority to Chinese Patent Application No. 202510687515.1, filed on May 27, 2025, titled “Electric winch with autonomous clutch” before the China National Intellectual Property Administration, the disclosure of which is incorporated herein by reference in entirety.

### TECHNICAL FIELD

The present disclosure relates to the field of transmission or traction equipment, and in particular to an electric winch with autonomous clutch.

### BACKGROUND

Electric winches are powered by a motor, using a large transmission ratio to achieve sufficient speed reduction and torque increase, enabling them to lift or pull heavy objects. However, due to the large transmission ratio, the winch releases the rope slowly, resulting in lower work efficiency.

### SUMMARY

The purpose of the present disclosure is to at least partially overcome the deficiencies of the prior art, and to provide an electric winch that can freely release the rope while meeting the working requirements. When actively releasing the rope, the drum separates from the actuation device, autonomously controlling the rope release speed; when retracting the rope, the drum reliably engages, effectively improving work efficiency.

To achieve the above-mentioned objectives or one of them, the technical solution of the present disclosure is as follows:

An electric winch with autonomous clutch, wherein the electric winch comprises a speed change assembly, a power transmission assembly, and a contact clutch; the speed change assembly comprises a speed change input element and a speed change output element; the power transmission assembly comprises a power input component and a power output component; the contact clutch is disposed in the power transmission assembly, and connected to the power input component and the power output component of the power transmission assembly; the contact clutch is configured to disengage the power output component from the power input component, and to engage the power output component with the power input component when the power input component rotates actively; the power transmission assembly comprises a connection between the actuating element and the speed change input element of the speed change assembly, a connection between the speed change output element of the speed change assembly and the speed change input element of the next-stage speed change assembly, and a connection between the speed change output element of the speed change assembly and a drum of the winch.

Specifically, the power transmission assembly refers to the connection of power components in the winch other than the speed change assembly, including the connection between the actuator and the speed change input element of the first-stage speed change assembly, the connection between the speed change output element of the first-stage speed change assembly and the speed change input element of the second-stage speed change assembly, the connection between the speed change output element of the second-stage speed change assembly and the speed change input element of the third-stage speed change assembly, etc., that is, the connection between the speed change output element of the previous-stage speed change assembly and the speed change input element of the next-stage speed change assembly, and the connection between the speed change output element of the last-stage speed change assembly and the drum.

According to some embodiments of the present disclosure, it further comprises a fixing member; the contact clutch comprises a control bracket and a locking block; the control bracket is frictionally connected to the fixing member, and the locking block comprises a center-proximal end and a center-distal end; the control bracket has a groove, and the center-distal end of the locking block passes through the groove and is capable of rotating around the center-proximal end of the locking block; the locking block is configured to simultaneously contact the power input component and the power output component so that the contact clutch is engaged when the locking block rotated to a first position; and configured not to contact the power output component or the power input component so that the contact clutch is disengaged when the locking block rotated to a second position.

According to some embodiments of the present disclosure, the speed change assembly is a planetary gear mechanism, comprising a sun gear, a ring gear, and a planet carrier; the speed change input element is the sun gear, and the speed change output element is the planet carrier or the ring gear.

According to some embodiments of the present disclosure, the contact clutch comprises a locking block and a return spring; the return spring causes the locking block to tend to move inward toward the power input component; the locking block is configured to simultaneously contact the power input component and the power output component so that the contact clutch is engaged when the locking block situated in an outer position, and configured not to contact the power output component or the power input component so that the contact clutch is disengaged when the locking block situated in an inner position.

According to some embodiments of the present disclosure, the fixing member comprises a housing of the winch fixedly installed, and parts directly or indirectly fixedly connected to the housing.

According to some embodiments of the present disclosure, a contact surface between the locking block and the power input component comprises an inclined surface A and a curved surface B, and an angle formed by a line connecting two ends of the outer circular arc of the locking block and the inclined surface A is an obtuse angle; the curved surface B is a flat, a sphere, a cylinder, a parabola, a hyperboloid, or a combination of the above curved surfaces.

The winch of the present disclosure has the following advantages:

The system allows for switching between free rope release and controlled rope release as needed: When rapid rope release is required, the contact clutch disengages, allowing the drum to rotate freely and the user to control the release speed. When controlled rope release is required, the contact clutch engages, enabling controlled rope release under load. When the actuation device works to retract the rope, the contact clutch automatically engages, allowing the winch to wind up the rope normally.

### BRIEF DESCRIPTION OF THE DRAWINGS

FIG. 1 is a schematic view of an electric winch with autonomous clutch according to Embodiment 1 of the present disclosure;

FIG. 2 is a schematic view showing the installation of the contact clutch in Embodiment 1;

FIG. 3 is an axial schematic view showing the contact clutch disengagement in Embodiment 1;

FIG. 4 is an axial schematic view showing the contact clutch engagement in Embodiment 1;

FIG. 5 is a schematic view of the contact clutch according to Embodiment 2 of the present disclosure;

FIG. 6 is a schematic view of the contact clutch according to Embodiment 3 of the present disclosure;

FIG. 7 is a schematic view of the locking block in the contact clutch according to another embodiment of the present disclosure.

### DETAILED DESCRIPTION OF EMBODIMENTS

Exemplary embodiments of the present disclosure are described in detail below with reference to the accompanying drawings, wherein the same or similar reference numerals denote the same or similar elements. Furthermore, in the following detailed description, numerous specific details are set forth for ease of explanation to provide a thorough understanding of the embodiments disclosed herein. However, it will be apparent that one or more embodiments may be practiced without these specific details. In other instances, well-known structures and apparatuses are illustrated to simplify the drawings.

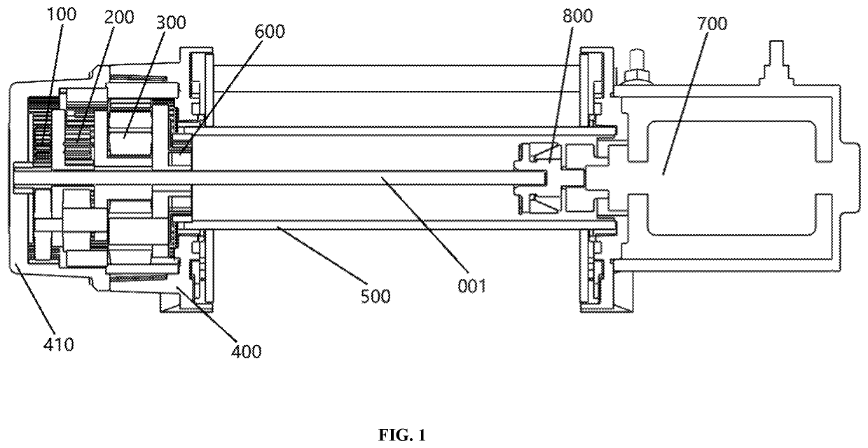

FIGS. 1-4 illustrate an embodiment of an electric winch employing the autonomous clutch of the present disclosure. The electric winch includes a motor 700, a transmission and braking assembly 800, a drum assembly 500, an actuator 001 connected to the motor 700 via the transmission and braking assembly 800, a fixedly mounted fixing member 400, and a housing 410 fixedly mounted to the fixing member 400. The fixing member 400 and housing 410 contain a gear transmission mechanism and a contact clutch. The gear transmission mechanism includes the following speed change assemblies: a first-stage planetary gear mechanism 100, a second-stage planetary gear mechanism 200, and a third-stage planetary gear mechanism 300. The power transmission assembly includes the connection between the actuator 001 and the speed change assembly, the connection between the previous and next-stage speed change assemblies, and the connection between the speed change assembly and the drum assembly 500, etc., and is divided into a power input component and a power output component according to the power transmission direction. In this embodiment, the contact clutch 600 is disposed in the power transmission assembly that connects the third-stage planetary gear mechanism 300 and the drum assembly 500. The planet carrier assembly 310 of the third-stage planetary gear mechanism 300 is the speed change output element of the speed change assembly and the power input component in this power transmission assembly. The drum assembly 500 is the power output component in this power transmission assembly.

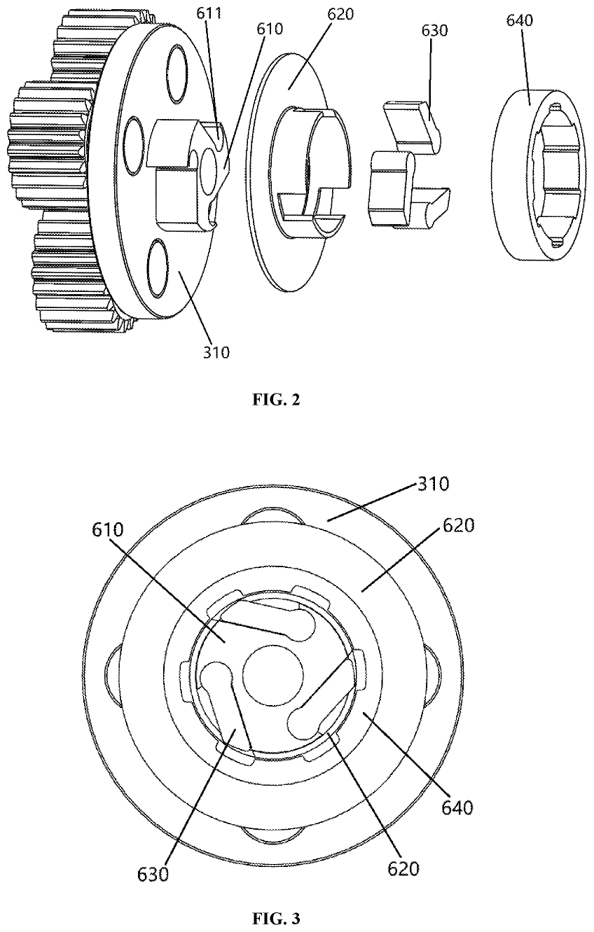

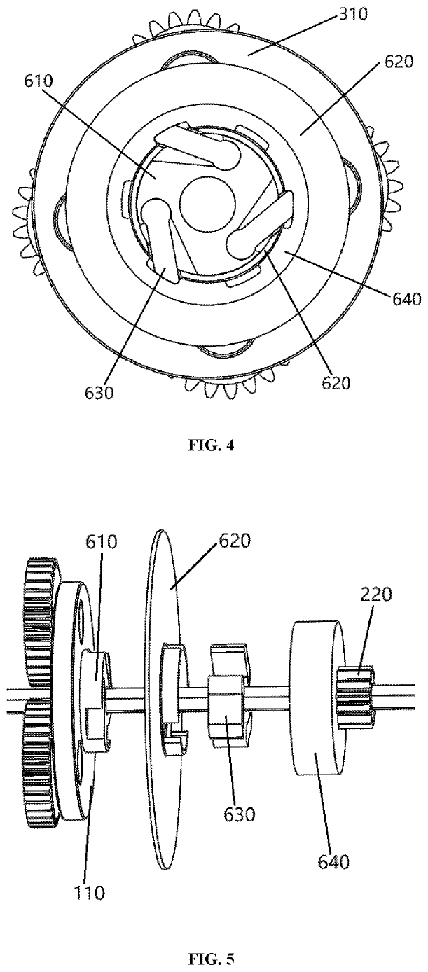

FIG. 2 shows the structure and installation of the contact clutch in Embodiment 1. The planetary carrier assembly 310, the speed change output element of the third-stage planetary gear mechanism 300, is connected to the drum assembly 500 as a power transmission assembly. The planetary carrier assembly 310 is the power input component, and the outer ring 640, fixedly installed with the drum assembly 500, is the power output component. The inner element 610 of the contact clutch 600 is fixedly installed with the planetary carrier assembly 310, the control bracket 620 is frictionally mounted with the fixing member 400, and the outer ring 640 is fixedly installed with the drum assembly 500. The inner element 610 has a groove 611 containing a partially circular hole. The center-proximal end of the locking block 630 includes a cylindrical surface, which mates with the partially circular hole in the groove 611. The center-distal end of the locking block 630 extends out of the outer surface of the inner element 610 and inserts into the groove of the control bracket 620. The inner surface of the outer ring 640 has a groove that matches the protruding end of the locking block 630. The portion of the control bracket 620 with groove feature, with an outer diameter smaller than the minimum inner diameter of the outer ring 640, and an inner diameter larger than the outer diameter of the inner element 610. The locking block 630 is rotatable about its cylindrical mounting end. FIG. 3 shows the second position of the locking block 630, where its distal end is inserted into the groove of the control bracket 620, and its outer surface does not exceed the outer surface of the control bracket 620. The locking block 630 does not contact the power output component 640, and the contact clutch 600 is disengaged. FIG. 4 shows the first position of the locking block 630. Compared with the second position, the center-distal end of the locking block 630 rotates clockwise about its cylindrical center-proximal end, protruding from the groove of the control bracket 620 and inserting into the groove of the outer ring 640. At this point, the locking block simultaneously contacts both the power input component 310 and the power output component 640, and the contact clutch 600 is engaged.

FIG. 5 shows Embodiment 2 in which the contact clutch 600 is installed in another power transmission assembly. The contact clutch 600 is located between the planet carrier 110, the speed change output element of the first-stage planetary gear mechanism 100, and the sun gear 220, the speed change input element of the second-stage planetary gear mechanism 200. The planet carrier 110 is the power input component, and the sun gear 220 is the power output component. The control bracket 620 is frictionally mounted with the fixing member, and the outer ring 640 is fixedly mounted with the sun gear 220. The specific structural principle is basically the same as that of Embodiment 1, and will not be described in detail here.

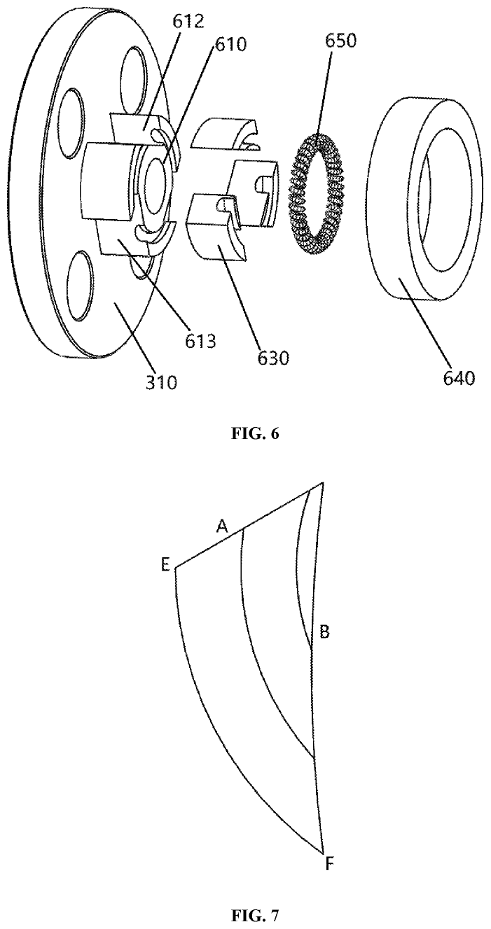

FIG. 6 shows Embodiment 3 of the contact clutch. The contact clutch 600 is positioned between the planetary carrier assembly 310 (the speed change output element) of the third-stage planetary gear mechanism 300 and the drum assembly 500. The planetary carrier assembly 310 serves as the power input component, and the outer ring 640, fixedly connected to the drum assembly 500, serves as the power output component. The inner element 610 of the contact clutch 600 is fixedly mounted to the planetary carrier assembly 310. The inner element 610 has a wedge-shaped groove for mounting a locking block 630. The wedge-shaped groove includes an inclined surface 612 and a curved surface 613, which respectively mate with the A and B surfaces of the locking block 630. Annular grooves are also provided on the surfaces of the inner element 610 and the wedge-shaped locking block 630 facing the drum assembly 500 to mount an annular return spring 650. In Embodiment 3, the B surface of the locking block 630 is planar; in FIG. 7, the B surface of the locking block 630 is an arc surface.

The working process of the electric winch with autonomous clutch of Embodiment 1 of the present disclosure is described below with reference to FIGS. 1-4:

The motor 700 drives the actuator 001 to rotate through the transmission and braking assembly 800. The actuator 001 is connected to the sun gear 120 in the first-stage planetary gear mechanism 100, driving the sun gear 120 to rotate. The rotation is transmitted to the planet carrier 310 of the third-stage planetary gear mechanism 300 through three speed change assemblies. The engagement and disengagement of the drum assembly 500 and the gear mechanism are autonomously controlled by the contact clutch 600.

When the drum assembly 500 needs to be separated/disengaged, if the locking block 630 is not in the second position, the motor 700 reverses, driving the inner element 610 to rotate clockwise (view from FIG. 3), causing the cylindrical mounting end of the locking block 630 to rotate clockwise as well. The outer ring 640 is fixedly connected to the drum assembly 500 and remains stationary. Due to the friction between the control bracket 620 and the fixing member 400, the control bracket 620 tends to remain stationary, and the center-distal end of the locking block 630 inserted into the groove of the control bracket 620 also tends to remain stationary. Therefore, the locking block 630 rotates counterclockwise around its center-proximal end to the second position. At this time, the center-distal end of the locking block 630 is located in the groove of the control bracket 620, and its end face does not extend beyond the outer surface of the control bracket 630, and it is not in contact with the outer ring 640 at all. The contact clutch 600 disengages, and the drum 900 can rotate freely without affecting the working state of the contact clutch 600.

When the drum assembly 500 needs to be engaged, the motor 700 rotates forward, driving the inner element 610 and the center-proximal end of the locking block 630 to rotate counterclockwise. Since the control bracket 620 tends to be stationary, the groove of the control bracket 620 causes the center-distal end of the locking block 630 to tend to remain stationary. Therefore, the locking block 630 rotates clockwise around its support end, opening outward. When it rotates to the first position, the protruding end of the locking block 630 is inserted into the groove of the outer ring 640. Therefore, the inner element 610 drives the outer ring 640 to rotate together through the locking block 630. That is, the drum assembly 500 and the gear mechanism are engaged through the contact clutch 600.

The above analysis shows that when the drum needs to be disengaged, the motor 700 only needs to briefly reverse for a short time; when the electric winch needs to work to take in the rope, the motor 700 rotates forward, and the contact clutch 600 engages, thus achieving normal operation. When the electric winch needs to release the rope under load, i.e., when there is a load on the drum assembly 500, and the motor 700 needs to reverse to release the rope, since the drum assembly 500 is always rotating clockwise under load, even if the motor 700 reverses, the contact clutch 600 can still reliably engage due to the load on the drum assembly 500, thus achieving the work process of releasing the rope under load.

In Embodiment 2 shown in FIG. 5, the structural and principle of the contact clutch 600 is the same as that of Embodiment 1, except that the installation position is different. Therefore, when the contact clutch 600 is disengaged or engaged, only the disengagement position of the drum assembly 500 and the motor 700 is different. The working process, working principle and working effect are the same, and will not be described in detail here.

In Embodiment 3 shown in FIG. 6, the contact clutch 600 causes the locking block 630 to tend to move inward via the return spring 650. When the wedge-shaped locking block 630 is located at its innermost position, its outer surface does not exceed the outer surface of the inner element 610 and does not contact the outer ring 640, thus disengaging the contact clutch 600. The mounting feature of the locking block 630 and the inner element 610 is wedge-shaped, and the angle formed between the line connecting to the endpoints of the arc-shaped outer surface of the locking block 630, i.e., the EF line, and the inclined plane A is an obtuse angle. When the motor 700 drives the planetary carrier 310 to rotate clockwise, the wedge-shaped locking block 630 moves outward under the action of centrifugal force, overcoming the force of the return spring 650, and contacts the outer ring 640. Due to the friction generated on the contact surface by the centrifugal force, the wedge-shaped locking block 630 tends to move towards its smaller end. The friction on the outer surface and the supporting force on the wedge-shaped groove support surface 613 work together to make the wedge-shaped locking block 630 stuck between the inner element 610 and the outer ring 640, and the contact clutch 600 engages. When the motor 700 drives the planetary carrier 310 to rotate counterclockwise, the friction on the outer surface of the wedge-shaped locking block 630 causes it to move towards its larger end, contacting the inclined surface 612 of the wedge-shaped groove. The friction and the supporting force of the inclined surface 612 work together to make the wedge-shaped locking block 630 move inward, and the contact clutch 600 disengages. When the support surface 613 and the B surface of the locking block 630 are curved surfaces or combined curved surfaces, the working performance of the contact clutch 600 can be further optimized through reasonable structural design.

In other preferred embodiments of the present disclosure, the contact clutch 600 is disposed within the remaining power transmission assembly.

Although embodiments of the present disclosure have been shown and described, it will be understood by those skilled in the art that variations may be made to these embodiments without departing from the principles and spirit of the present disclosure. The scope of the present disclosure is defined by the appended claims and their equivalents.

What is claimed is:

1. An electric winch with autonomous clutch, wherein the electric winch comprises a speed change assembly, a power transmission assembly, and a contact clutch; the speed change assembly comprises a speed change input element and a speed change output element; the power transmission assembly comprises a power input component and a power output component; the contact clutch is disposed in the power transmission assembly, and connected to the power input component and the power output component of the power transmission assembly; the contact clutch is configured to disengage the power output component from the power input component, and to engage the power output component with the power input component when the power input component rotates actively; the power transmission assembly comprises a connection between the speed change output element of the speed change assembly and the speed change input element of the next-stage speed change assembly, and a connection between the speed change output element of the speed change assembly and a drum of the winch.

2. The electric winch with autonomous clutch according to claim 1, wherein it further comprises a fixing member; the contact clutch comprises a control bracket and a locking block; the control bracket is frictionally connected to the fixing member, and the locking block comprises a center-proximal end and a center-distal end; the control bracket has a groove, and the center-distal end of the locking block passes through the groove and is capable of rotating around the center-proximal end of the locking block; the locking block is configured to simultaneously contact the power input component and the power output component so that the contact clutch is engaged when the locking block rotated to a first position; and configured not to contact the power output component or the power input component so that the contact clutch is disengaged when the locking block rotated to a second position.

3. The electric winch with autonomous clutch according to claim 1, wherein the contact clutch comprises a locking block and a return spring; the return spring causes the locking block to tend to move inward toward the power input component; the locking block is configured to simultaneously contact the power input component and the power output component so that the contact clutch is engaged when the locking block situated in an outer position, and configured not to contact the power output component or the power input component so that the contact clutch is disengaged when the locking block situated in an inner position.

4. The electric winch with autonomous clutch according to claim 2, wherein the fixing member comprises a housing of the winch fixedly installed, and parts directly or indirectly fixedly connected to the housing.

5. The electric winch with autonomous clutch according to claim 1, wherein the speed change assembly is a planetary gear mechanism, comprising a sun gear, a ring gear, and a planet carrier; the speed change input element is the sun gear, and the speed change output element is the planet carrier or the ring gear.

6. The electric winch with autonomous clutch according to claim 3, wherein a contact surface between the locking block and the power input component comprises an inclined surface A and a curved surface B, and an angle formed by a line connecting two ends of the outer circular arc of the locking block and the inclined surface A is an obtuse angle; the curved surface B is a flat, a sphere, a cylinder, a parabola, a hyperboloid, or a combination of the above curved surfaces.
